(19) United States
(12) Patent Application Publication
(10) Pub. No.: US 2026/0127443 A1
(43) Pub. Date: May 7, 2026

(54) METHOD, APPARATUS, AND SYSTEM FOR REINFORCEMENT LEARNING USING OFFLINE DATA

(71) Applicant: LG MANAGEMENT DEVELOPMENT INSTITUTE CO., LTD., Seoul (KR)

(72) Inventors: Jeong Hye KIM, Seoul (KR); Yong Jae SHIN, Seoul (KR); Kang Hoon LEE, Seoul (KR); Whi Young JUNG, Seoul (KR); Sung Hoon HONG, Seoul (KR); Deun Sol YOON, Seoul (KR); Woohyung LIM, Seoul (KR)

(21) Appl. No.: 19/433,955

(22) Filed: Dec. 28, 2025

Related U.S. Application Data
(63) Continuation of application No. PCT/KR2025/013602, filed on Sep. 3, 2025.

(30) Foreign Application Priority Data
Sep. 13, 2024 (KR) 10-2024-0126112
Aug. 8, 2025 (KR) 10-2025-0109486

(51) Int. Cl. G06N 3/092

(52) U.S. Cl. CPC G06N 3/092

(57) ABSTRACT

A system for reinforcement learning includes at least one processor, and at least one memory storing at least one instruction that, when executed by the at least one processor, is configured to: perform offline reinforcement learning; and perform online reinforcement learning. The performing of the offline reinforcement learning includes identifying a data-retained region and a data-unretained region, and reducing a Q-value estimated in the data-unretained region.

### CROSS REFERENCE TO RELATED APPLICATIONS

This application is a Bypass Continuation of International Patent Application No. PCT/KR2025/013602, filed on Sep. 3, 2025, which claims priority from and the benefit of Korean Patent Application No. 10-2024-0126112, filed on Sep. 13, 2024, and Korean Patent Application No. 10-2025-0109486, filed on Aug. 8, 2025, each of which is hereby incorporated by reference for all purposes as if fully set forth herein.

### BACKGROUND

### Field

Embodiments of the invention relate generally to a method, apparatus, and system for reinforcement learning using offline data, and more particularly, one embodiment of the present disclosure provides a method for appropriately adjusting a Q-value without overestimating the Q-value for an out-of-distribution space in which data is not yet available when performing reinforcement learning using offline data.

### Discussion of the Background

Reinforcement learning is a method in which an agent learns how to make decisions by interacting with an environment, and is an artificial intelligence learning method mainly used in robot control, autonomous driving, and the like. The reinforcement learning may include online reinforcement learning and offline reinforcement learning. Online reinforcement learning is a learning method in which an agent directly interacts with the environment to collect data. In contrast, offline reinforcement learning is reinforcement learning in which the agent does not directly interact with the environment, and is a method in which a behavior algorithm separately exists to learn a policy based on fixed data collected in advance without interaction with the environment. Offline reinforcement learning has an advantage in that learning may be performed without risks to an actual environment in robots, autonomous driving, and the like, but there is a problem in that inference capability is degraded for situations other than the fixed data collected in advance. Accordingly, a method of training by utilizing both online reinforcement learning and offline reinforcement learning is currently being researched.

The above information disclosed in this Background section is only for understanding of the background of the inventive concepts, and, therefore, it may contain information that does not constitute prior art.

### SUMMARY

One embodiment of the present disclosure is directed to providing a method for preventing overestimation of a Q-value in offline reinforcement learning and online reinforcement learning.

Additional features of the inventive concepts will be set forth in the description which follows, and in part will be apparent from the description, or may be learned by practice of the inventive concepts.

According to one embodiment of the present disclosure, a system for reinforcement learning may include at least one processor, and at least one memory storing at least one instruction that, when executed by the at least one processor, is configured to perform offline reinforcement learning, and perform online reinforcement learning. The performing of the offline reinforcement learning includes identifying a data-retained region and a data-unretained region, and reducing a Q-value estimated for the data-unretained region.

The reducing of the Q-value estimated for the data-unretained region may include an operation of utilizing reward scaling that multiplies a reward function used in the offline reinforcement learning by a constant c_{reward} greater than 1 to reduce the Q-value.

The reducing of the Q-value estimated for the data-unretained region may include an operation of performing reward scaling that multiplies a reward function used in the offline reinforcement learning by a constant c_{reward} greater than 1, an operation of performing layer normalization using a reward obtained by the reward scaling as an input, and an operation of learning a critic ensemble including a plurality of critic networks in which the layer normalization is performed.

The performing of the online reinforcement learning may include an operation of performing online fine-tuning by utilizing reward scaling that multiplies a reward function of a replay buffer used in the online reinforcement learning by the constant c_{reward}.

The constant c_{reward} may be set to a value of 10 or greater.

The reducing of the Q-value estimated for the data-unretained region may include an operation of penalizing that sets the Q-value for the data-unretained region to be equal to or less than a predetermined value.

The penalizing may include: calculating a penalty loss, calculating a temporal-difference (TD) loss, determining a first loss based on the penalty loss and the TD loss, and the performing at least one of the offline reinforcement learning and the online reinforcement learning based on the first loss.

The first loss may be determined by adding, to the TD loss, a value obtained by multiplying the penalty loss by a weight value.

According to another embodiment of the present disclosure, a method for reinforcement learning performed by at least one processor may include an operation of performing offline reinforcement learning, and an operation of performing online reinforcement learning. The performing of the offline reinforcement learning may include an operation of identifying a data-retained region and a data-unretained region, and an operation of reducing a Q-value estimated for the data-unretained region.

The reducing of the Q-value estimated for the data-unretained region may include an operation of utilizing reward scaling that multiplies a reward function used in the offline reinforcement learning by a constant c_{reward} greater than 1 to reduce the Q-value.

The reducing of the Q-value estimated for the data-unretained region may include an operation of performing reward scaling that multiplies a reward function used in the offline reinforcement learning by a constant c_{reward} greater than 1, an operation of performing layer normalization using a reward obtained by the reward scaling as an input, and an operation of learning a critic ensemble including a plurality of critic networks in which layer normalization is performed.

The performing of the online reinforcement learning may include an operation of performing online fine-tuning by utilizing reward scaling that multiplies a reward function of a replay buffer used in the online reinforcement learning by the constant c_{reward}.

The reducing of the Q-value estimated for the data-unretained region may include an operation of penalizing that sets the Q-value for the data-unretained region to be equal to or less than a predetermined value.

The method may include: calculating a penalty loss, calculating a temporal-difference (TD) loss, determining a first loss based on the penalty loss and the TD loss, and performing at least one of the offline reinforcement learning and the online reinforcement learning based on the first loss. The first loss may be determined by adding, to the TD loss, a value obtained by multiplying the penalty loss by a weight value.

According to another embodiment of the present disclosure, a computer-readable recording medium including at least one program for executing a method, the method includes: performing offline reinforcement learning; and performing online reinforcement learning. The performing of the offline reinforcement learning includes identifying a data-retained region and a data-unretained region; and reducing a Q-value estimated for the data-unretained region.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1A is a schematic diagram illustrating a Q-value corresponding to ground truth according to one embodiment of the present disclosure.

FIG. 1B is a schematic diagram illustrating a Q-value estimated by linear extrapolation according to one embodiment of the present disclosure.

FIG. 2 is a schematic diagram illustrating a target Q-value function according to one embodiment of the present disclosure.

FIG. 3 is a schematic diagram illustrating a reward scaling method according to one embodiment of the present disclosure.

FIG. 4 is a schematic diagram illustrating performance improvement results by reward scaling according to one embodiment of the present disclosure.

FIG. 5 is a schematic diagram illustrating a method of penalizing infeasible action according to one embodiment of the present disclosure.

FIG. 6 is a schematic diagram illustrating performance of a method according to one embodiment of the present disclosure.

FIG. 7 is a schematic flowchart illustrating a method for reinforcement learning according to one embodiment of the present disclosure.

FIG. 8 is a schematic block diagram illustrating a system for reinforcement learning according to one embodiment of the present disclosure.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

The expression “configured to (or set to)” as used throughout the present disclosure may, depending on the contexts, be used interchangeably with, for example, “suitable for,” “having the capacity to,” “designed to,” “adapted to,” “made to,” or “capable of.” The term “configured to (or set to)” does not necessarily mean only “specifically designed to” in hardware. Instead, in certain contexts, the expression “a system configured to” may mean that the system is “capable of” in conjunction with other devices or parts. For example, the phrase “a processor configured to (or set to) perform A, B, and C” may mean a dedicated processor (e.g., an embedded processor) for performing corresponding operations, or a generic-purpose processor (e.g., a CPU or application processor) that can perform corresponding operations by executing one or more software programs stored in memory.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Agents performing online reinforcement learning may learn a strategy of making optimal decisions by interacting with an environment in real time. However, such interaction with the environment may result in a considerable data collection cost by learning from experience data collected by the agent or may expose the agent to considerable risk, and to alleviate such drawbacks, offline reinforcement learning of deriving an optimal policy from data collected in advance is being researched.

In addition, the agent trained using offline reinforcement learning may be deployed in an actual environment to further learn knowledge for making optimal decisions. However, due to a limited range of offline data, offline reinforcement learning may overestimate a Q-value of out-of-distribution (OOD) action, thereby causing an extrapolation error that degrades overall performance.

Throughout the present disclosure, extrapolation may refer to a process of estimating a value of a variable based on relationships with other variables beyond an original observation range. An extrapolation error may refer to an error occurring in an extrapolation process. In addition, a Q-value may refer to an estimated value of a cumulative reward expected when a certain action is taken in a specific state. While a reward is an immediate return received by the agent, the Q-value may represent a long-term return.

In one embodiment, when performing reinforcement learning using offline data, a Q-value extrapolation error in which a Q-value estimated by a Q-network significantly differs from an actual value may occur when the agent encounters a situation not included in a distribution of training data in an offline situation. This is because, in offline reinforcement learning, the Q-network is trained using data collected by a past policy or different policy rather than data collected by a current policy. In particular, in a situation that the agent encounters for the first time in the offline situation, the Q-network may perform inaccurate estimation such as linear extrapolation beyond a data range, thereby causing the Q-value to be overestimated or underestimated. As a result, the agent may rely on the erroneously estimated Q-value and select an irrational action, thereby causing unstable learning or policy degradation.

In order to solve the above problems, one embodiment of the present disclosure provides a method of performing reward scaling with layer normalization (RS-LN) and a penalty mechanism for infeasible actions, thereby gradually reducing a Q-value beyond the data range to perform stable decision-making.

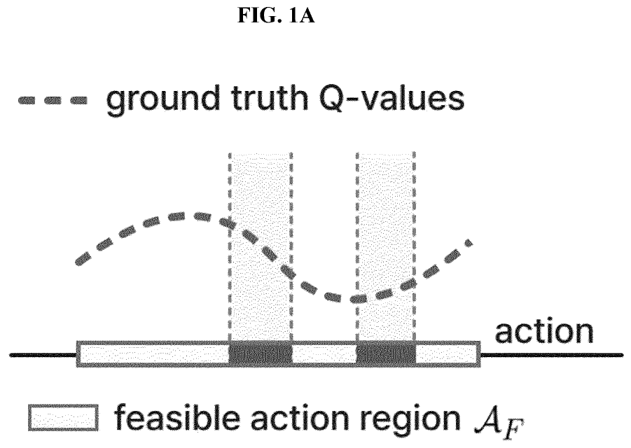

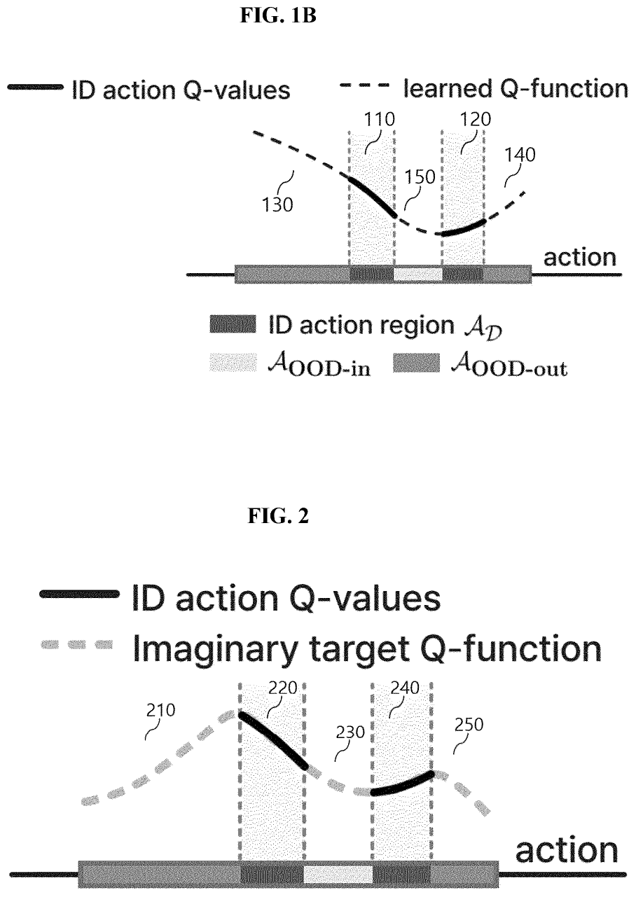

FIG. 1A is a schematic diagram illustrating a Q-value corresponding to ground truth according to one embodiment of the present disclosure, and FIG. 1B is a schematic diagram illustrating a Q-value estimated by linear extrapolation according to one embodiment of the present disclosure.

A method of performing learning by the agent when the ground truth is the same as a graph of FIG. 1A will be described. In a situation in which data in in-distribution (ID) action regions 110 and 120 may be provided as shown in FIG. 1B, when the agent infers an internal region A_{ODD-in} 150 existing between the ID action regions and external regions A_{ODD-out} 130 and 140 existing outside the ID action regions, by linear extrapolation, the agent may infer a tendency according to linear extrapolation as the forms of 130, 140, and 150 of FIG. 1B. In this case, when the agent simply performs linear extrapolation, a deviation from the actual ground truth as shown in FIG. 1A may occur.

One factor of extrapolation errors in offline reinforcement learning may be a tendency of linear extrapolation beyond a collected data range. Rectified linear unit (ReLU)-based Multi-layer perceptrons (MLPs) may often, in inferring the external regions A_{ODD-out} 130 and 140 of observed data, perform estimation of a tendency in which Q-values continuously increase beyond the boundary as in the external region A_{ODD-out} 140 or perform estimation of a tendency in which Q-values continuously decrease beyond the boundary as in the external region A_{ODD-out} 130. For example, when data 110 and 120 in the ID action regions are given, the ReLU-based MLPs, in inferring the external regions A_{ODD-out} 130 and 140 of the data, tend to estimate that Q-values linearly and continuously decrease in the external region A_{ODD-out} 130 adjacent to the data region 110 in which the Q-values decrease, and estimate that Q-values linearly and continuously increase in the external region A_{ODD-out} 140 adjacent to the data region 120 in which the Q-values increase. Due to such tendencies, overestimation of the Q-value may occur for the OOD actions. Accordingly, a method for reinforcement learning using offline data may require a method for effectively limiting the Q-value outside a data range.

FIG. 2 is a schematic diagram illustrating a target Q-value function according to one embodiment of the present disclosure.

Referring to FIG. 2, in a situation in which data in in-distribution (ID) action regions 220 and 240 are provided, an agent may infer an internal region A_{ODD-in} 230 existing between the ID action regions and external regions A_{ODD-out} 210 and 250 existing outside the ID action regions. In particular, in inferring the external regions A_{ODD-out} 210 and 250, the agent may perform inference in which the Q-values decrease as the distance from the ID action regions increases as shown in the forms of 210 and 250 of FIG. 2. One embodiment of the present disclosure provides a method of solving the above-mentioned problems by utilizing at least one of a reward scaling method with layer normalization and a method of penalizing infeasible actions, thereby enabling the agent according to one embodiment to aim to estimate the Q-value as shown in FIG. 2.

A reinforcement learning problem may be formalized as a Markov Decision Process (MDP) [symbol] = [symbol] ρ₀, S, [symbol] , P, [symbol] , γ [symbol] . Here, ρ₀ may denote an initial state distribution, S may denote a state space, A may denote an action space, P(sₜ₊₁|sₜ, aₜ) may denote a state transition function, [symbol] (sₜ, aₜ) may denote a reward function, and γ∈(0, 1) may denote a factor applied when a future reward is converted into a current value, in particular, a discount factor.

The action space A may be a set of actions, and may include an action space in the ID action region A_{D}, an action space in an feasible action region A_{F} (e.g., [−1, 1]ⁿ) capable of being feasible by the agent, and action space in an infeasible action region A_{I} composed of actions capable of being infeasible by the agent in any state.

In one embodiment, in offline reinforcement learning, since a set Aₛ of actions in a specific state “s” may be determined within the action space in A_{F}=[−1, 1]ⁿ, an out-of-distribution (OOD) action [symbol] _{OOD}(s)={a∈ [symbol] _{F}|a∉ [symbol] ₛ}, in particular, an action not present in the data, may occur, and when a policy selects such an action not present in data, the Q-network is required to perform extrapolation. Such extrapolation may be a cause of an error.

Among the OOD actions, an action inside a convex hull (e.g., region 230 of FIG. 2) and an action outside the convex hull (for example, regions 210 and 250 of FIG. 2) have different properties and need to be distinguished. Firstly, the convex hull may be a safe extrapolation-possible region that is inferred from given data and may refer to a set of all points that are made by linearly combining various actions existing in Aₛ, and a region inside the convex hull may be defined as in the following Equation 1. For example, the region 150 of FIG. 1B may be a region inside the convex hull.

$$Conv ( {𝒜}_{s} ) = \{ {\sum }_{i = 1}^{n} {λ}_{i} {a}_{i} \vert {λ}_{i} \geq 0 , {\sum }_{i = 1}^{n} {λ}_{i} = 1 , {a}_{i} ∈ {𝒜}_{s} \} \qquad Equation 1$$

Here, aᵢ is an i-th action among actions belonging to Aₛ, and λᵢ is an i-th non-negative weight value.

The region 150 inside the convex hull of FIG. 1B may be inferred similarly to FIG. 1A corresponding to the ground truth, whereas the regions 130 and 140 outside the convex hull of FIG. 1B may be inferred dissimilarly to FIG. 1A. In particular, since A_{ODD-in}(s) is inside the convex hull from data, extrapolation may be relatively safely performed, and since A_{ODD-out}(s) is located outside observed data, risky extrapolation with low prediction reliability may be performed. The ODD action a may be classified as in the following Equation 2.

$$a ∈ \{ \begin{matrix}{𝒜}_{OOD - in} ( s ) , & if a ∈ Conv ( {𝒜}_{s} ) , \\ {𝒜}_{OOD - out} ( s ) , & if a ∉ Conv ( {𝒜}_{s} ) .\end{matrix} \qquad Equation 2$$

In particular, in A_{ODD-in}(s), there is no particular problem in inference by the agent, but in A_{ODD-out}(s), since the ReLU-based MLP tends to behave linearly beyond a data range, an increasing or decreasing trend at a boundary of the convex hull may be extrapolated, thereby causing the inference results to deviate from the ground truth. In particular, since there is no training data for A_{ODD-out}(s), inference of Q-values in A_{ODD-out}(s) may cause an increase in an uncontrollable error possibility. Accordingly, one embodiment of the present disclosure may propose a method capable of reducing a Q-value inference error.

In fact, in a region beyond a given data range, the agent may not capture the actual tendency of the data through a neural network. Therefore, in offline reinforcement learning, in order to select an optimal action within the given data range, the Q-values in A_{ODD-out}(s) may need to be less than a maximum Q-value within the data range. Therefore, according to one embodiment of the present disclosure, in order for a curve of A_{ODD-out}(s) to be maintained less than or equal to a maximum value within the data, extrapolation in which the curve becomes flattened or reduced at the boundary of the convex hull Conv(As) may be performed.

According to one embodiment, the agent may estimate the Q-value in the region A_{ODD-in} 230 inside the convex hull similarly to the region 150 of FIG. 1B, but may estimate the Q-values in the regions 210 and 250 outside the convex hull so as to have lower Q-values differently from the regions 130 and 140 of FIG. 1B. Accordingly, an error rate by linear extrapolation may be reduced.

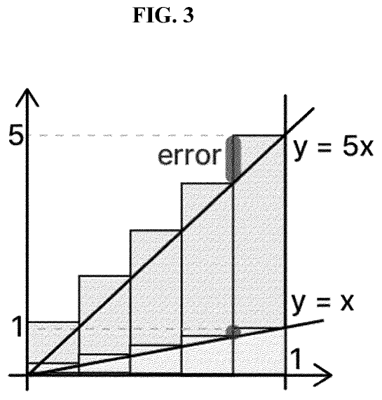

FIG. 3 is a schematic diagram illustrating a reward scaling method according to one embodiment of the present disclosure.

Temporal-difference (TD) reinforcement learning may refer to reinforcement learning that performs learning using an actual reward and an estimated future value for a next step. In addition, a TD target may refer to a target value used in the TD learning, may refer to a target value calculated by bootstrapping a current estimated value V_{θ}(s) or an action value Q_{θ}(s,a) with an experience of one step (or n steps) ahead, and may be defined as TD target=c_{reward}·r(s, a)+γG(s′). Here, r(s, a) may denote an immediate reward received after performing an action a in a current state s, γ∈[0,1] may denote a discount factor, and G(s′) may denote a current value estimate for a next state s′, which may be defined as in the following Equation 3.

$$G ( {s}^{′} ) = \{ \begin{matrix}{{a}^{′} ∼ {π}_{θ} ( \cdot \vert {s}^{′} )}_{} {Q}_{ϕ} ( {s}^{′} , {a}^{′} ) , & ( TD 3 + BC ) \\ {V}_{ψ} ( {s}^{′} ) , & ( IQL )\end{matrix} \qquad Equation 3$$

Here, π may denote a policy function, which represents a probability distribution of selecting a next action a′ in a specific state s′, and ψ may denote a parameter of a neural network representing a state value function V, which is used to predict a total reward expected in a state s. A TD target value may also be bootstrapped to include cumulative rewards of multiple steps.

In one embodiment, when training a Q-function Q_{φ} with a positive TD target, since a network is initially initialized with a weight value near zero, an output of Q_{φ} may start with a small value but gradually increase to match a target value as training progresses. In a learning process, a learning effect obtained from one input may also be propagated to other inputs recognized as similar by the network. For example, when Q_{φ} determines that an OOD action region A_{OOD-out}(s) is less similar to an ID action region A_{D}, a gradient update that increases Q-values may weakly act in an A_{OOD-out}(s) region. As a result, an increase of the Q-values for A_{OOD-out}(s) may naturally be suppressed compared to the ID action region A_{D}.

Accordingly, one embodiment of the present disclosure may disclose, through reward scaling, a method of enhancing an effect of Q_{φ}, in order to clarify a distinction between A_{D} and A_{OOD-out}(s).

As shown in a graph of FIG. 3, when a function y=x from x=0 to 1 (x=[0, 1]) is approximated with five equal intervals along the x-axis, the maximum error of y values may be 0.2, whereas when y=5x is approximated with five equal intervals along the x-axis, the maximum error of y values may be 1 so that the maximum error also increases in proportion to scaling.

In order to reduce such an error, a finer partitioning of an input space may be required. One embodiment of the present disclosure may be intended to apply this to the neural network.

In one embodiment, when an output scale increases, since a small difference of input leads to a large difference of output, the neural network may learn more fine-grained and expressive features. However, when an input range is also reduced (e.g., from [0, 1] to [0, 0.2]), a requirement for resolution may disappear. To prevent this, layer normalization (LN) may be utilized. Since LN always normalizes outputs of hidden layers within a unit sphere to maintain an input volume, an effect of increasing resolution may be stably obtained from reward scale expansion.

According to one embodiment of the present disclosure, when reward scaling is increased using LN, a perceived similarity between actions in a data range and actions outside the data range may be reduced. In addition, gradient updates for the ID actions may have a weak effect on predicting an OOD Q-value. This may lead to a decrease of the OOD Q-value beyond the data range. In addition, one embodiment of the present disclosure may penalize Q-values of infeasible actions far away from a feasible action region of the agent.

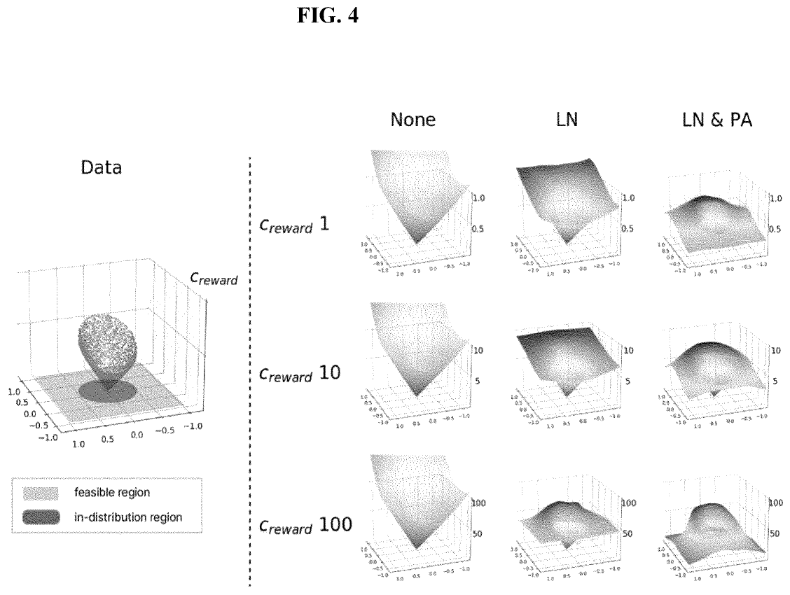

FIG. 4 is a schematic diagram illustrating performance improvement results by reward scaling according to one embodiment of the present disclosure.

A toy dataset may include 2D inputs=(x1, x2) in a shape of an inverted cone with an entrance obliquely cut. In particular, an embodiment in which c_{reward} is a reward scaling factor, a Q-function is defined as

$$y = f ( {x}_{1} , {x}_{2} ) = {c}_{reward} \cdot ( \sqrt{{x}_{1}^{2} + {x}_{2}^{2}} ) ,$$

and a feasible input region is set as (x₁, x₂)∈[−1, 1]² will be described as an example.

In one embodiment, when an in-distribution region is a region in which data is collected only in a region satisfying

$${x}_{1}^{2} + {x}_{2}^{2} \leq {0.5}^{2}$$

and the remaining

$${x}_{1}^{2} + {x}_{2}^{2} > {0.5}^{2}$$

region is an out-of-distribution (OOD) region, results of training a rectified linear unit (ReLU)-based Multi-layer perceptron (MLP) with c_{reward} of 1, 10, and 100 (a) without LN or PA (penalizing infeasible actions), (b) after applying LN, and (c) after applying both LN and PA may be as shown in FIG. 4.

Referring to FIG. 4, when the toy dataset is fitted without LN or PA applied, the Q-value in the OOD region may be explosively overestimated as shown in a first column (None column) of FIG. 4. In contrast, in a second column (LN column) of FIG. 4 in which the dataset is fitted with an MLP network using LN, it may be confirmed that sharp overestimation is somewhat prevented. In particular, when LN is used, linear extrapolation of the Q-value may be mitigated.

As a scale value of reward scaling increases, overestimation may be more strongly suppressed.

However, even when LN is applied, the Q-value of the A_{OOD-out}(s) region do not become lower than the Q-value of the ID region, and to address this, one embodiment of the present disclosure may, in addition to LN, impose a penalty so that the Q-value becomes close to zero in a region x1 or x2∈(−2000, −1000)∪(1000, 2000) far from a feasible region. Accordingly, as shown in a third column (LN and PA column) of FIG. 4, it may be confirmed that the Q-values are smoothly reduced as it moves away from the ID region. In particular, when a high reward factor is combined with the LN method, the Q-value in the A_{OOD-out}(s) region may become close to 0, and therefore, according to one embodiment of the present disclosure, the Q-value in the A_{OOD-out}(s) region may be effectively reduced by using LN and PA together.

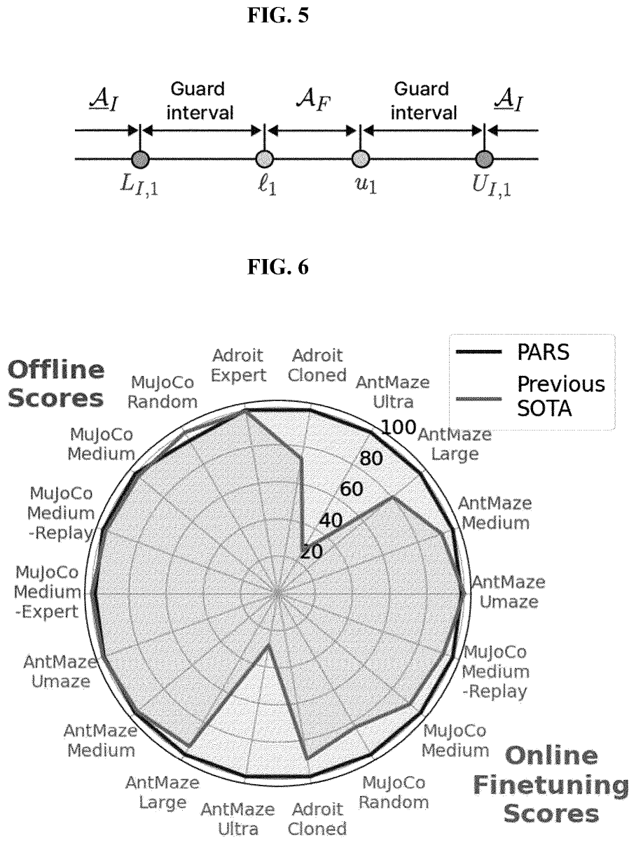

FIG. 5 is a schematic diagram illustrating a method of penalizing infeasible action according to one embodiment of the present disclosure.

Referring to FIG. 5, a relationship between a feasible action region A_{F} and an infeasible action region A_{I} in a one-dimensional action space (n=1) is shown. A Penalizing Infeasible Actions (PIA) loss may be considered in order to converge a Q-value in A_{I} to a minimum reference value Qₘᵢₙ. However, in order that a Q-function inside A_{F} is sufficiently trained with only data and is not significantly affected by constraints of A_{I}, a guard interval may exist between the two regions.

A subset of the infeasible action region may be defined as in the following Equation 4.

$${\underline{𝒜}}_{I} = {⋃}_{i = 1}^{n} \{ ( - ∞ , {L}_{I , i} ] ⋃ [ {U}_{I , i} , ∞ ) \} \qquad Equation 4$$

Here, n may denote an action dimension, L may denote a lower limit value of the infeasible action region in each action dimension, U may denote an upper limit value of the infeasible action region in each action dimension, and the feasible action region A_{F} is defined as

$${⋂}_{i = 1}^{n} \{ ( {ℓ}_{i} , {u}_{i} ) \} .$$

In order to secure the guard interval, L_{I,i}<lᵢ and uᵢ<U_{I,i} need to be satisfied.

A PA loss function minimizing the Q-value in the infeasible action region may be defined as in the following Equation 5.

$${ℒ}_{PA} = {min}_{ϕ} {s ∼ 𝒟 , a ∈ {\underline{𝒜}}_{I}}_{} [ {( {Q}_{ϕ} ( s , a ) - {Q}_{min} )}^{2} ] \qquad Equation 5$$

In this case, Es˜D may denote an expectation value for a state s sampled from a dataset D, and Qₘᵢₙ may be calculated as c_{reward}·rₘᵢₙ/(1−γ). When a minimum reward rₘᵢₙ of a task is not known, it may be replaced with a minimum reward observed from the data.

Accordingly, a modified total TD loss is obtained by adding a PA loss to an existing TD loss, where the final TD loss=existing TD loss+α×PA loss, which may be expressed as in the following Equation 6.

$${ℒ}_{Total} = {min}_{ϕ} \{ {s , a , {s}^{′} ∼ 𝒟}_{} [ {( {Q}_{ϕ} ( s , a ) - T ( s , a , {s}^{′} ) )}^{2} ] + α \cdot {{s , {s}^{′} ∼ 𝒟}_{a ∈ {\underline{𝒜}}_{I}}}_{} [ {( {Q}_{ϕ} ( s , a ) - {Q}_{min} )}^{2} ] \} \qquad Equation 6$$

Here, [symbol] (s, a, s′) may denote a policy function for selecting a next action a in a specific state s, and may be defined as c_{reward}·r(s, a)+γ [symbol] _{a′˜π}_{_{θ}}_{(⋅|s′)}Q_{φ}(s′, a′).

In particular, according to one embodiment of the present disclosure, by reducing the Q-value to a lower limit Qₘᵢₙ in the infeasible action region sufficiently separated from A_{F}, the Q-values may naturally decrease outside the boundary. Through this, overestimation of the Q-value in the OOD region may be more effectively suppressed.

FIG. 6 is a schematic diagram illustrating performance of a method according to one embodiment of the present disclosure.

PARS in FIG. 6 is an abbreviation of Penalizing infeasible Actions and Reward Scaling, and may refer to the method according to one embodiment of the present disclosure. Referring to FIG. 6, it may be confirmed that the method according to an embodiment of the present disclosure shows superior performance compared to other algorithms in both offline reinforcement learning and online fine-tuning reinforcement learning.

The method according to one embodiment may include a critic ensemble composed of up to ten critic networks. The critic ensemble may be operated by applying different objective functions for each of an offline learning stage and an online fine-tuning stage in a policy improvement process as in the following Equation 7.

$$Offline training : {max}_{θ} {s ∼ 𝒟 , a ∼ {π}_{θ} ( \cdot \vert s )}_{} [ λ ( {min}_{j = 1 , … , N} Q \text{?} ( s , a ) ) - β \cdot {( {π}_{θ} ( s ) - a )}^{2} ] , \qquad Equation 7$$

$$Online finetuning : {max}_{θ} {s ∼ 𝒟 , a ∼ {π}_{θ} ( \cdot \vert s )}_{} [ λ ( \text{?} ( s , a ) ) - {β ( {π}_{θ} ( s ) - a )}^{2} ]$$

$$\text{?} \text{indicates text missing or illegible when filed}$$

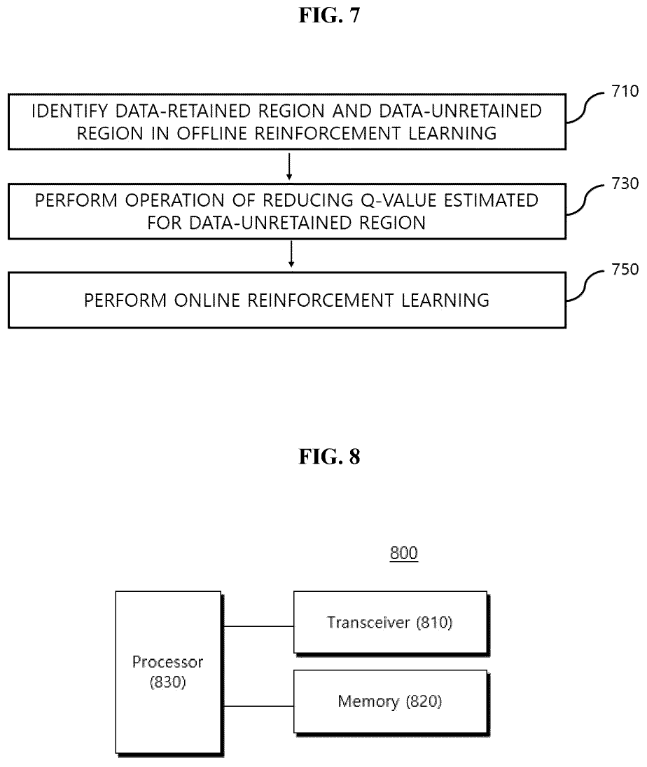

FIG. 7 is a schematic flowchart illustrating a method for reinforcement learning according to one embodiment of the present disclosure.

Referring to FIG. 7, in operation 710, a processor may identify a data-retained region and a data-unretained region in offline reinforcement learning. The data-retained region may include the in-distribution (ID) region, and the data-unretained region may include the out-of-distribution (OOD) region. For example, the data-retained region may include the regions 110 and 120 of FIG. 1B, and the data-unretained region may include the regions 130, 140, and 150 of FIG. 1B.

In operation 730, the processor may perform an operation of reducing a Q-value estimated for the data-unretained region. The operation of reducing the Q-value estimated for the data-unretained region may include an operation of reward scaling and an operation of penalizing.

The operation of reward scaling may include an operation of generating a new reward function by multiplying a reward function by a constant c_{reward} greater than 1. The operation of reward scaling may be utilized in both offline reinforcement learning and online reinforcement learning.

For example, the processor may perform reward scaling of multiplying the reward function used in offline reinforcement learning by the constant c_{reward} greater than 1 and perform online fine-tuning by utilizing reward scaling of multiplying a reward function of a replay buffer used in online reinforcement learning by the same constant c_{reward}.

The processor may perform reward scaling of multiplying the reward function used in offline reinforcement learning by the constant c_{reward} greater than 1, perform layer normalization using a reward obtained by the reward scaling as an input, and learn a critic ensemble including a plurality of critic networks in which the layer normalization is performed.

The constant c_{reward} is a constant greater than 1, for example, 10 to 100. As shown in the example of FIG. 4, when the constant c_{reward} is 10 or 100, it is confirmed that the Q-value is effectively reduced.

The processor may perform an operation of penalizing that sets the Q-value for the data-unretained region to be equal to or less than a predetermined value. For example, the processor may penalize the Q-value for the data-unretained region so as to converge to be equal to or less than a predetermined lower limit value.

The processor may calculate a penalty loss, calculate a temporal-difference (TD) loss, and determine a first loss based on the penalty loss and the TD loss. In addition, the processor may perform at least one of the offline reinforcement learning and the online reinforcement learning may be based on the first loss. Here, the first loss may be determined by adding, to the TD loss, a value obtained by multiplying the penalty loss by a weight value. For example, the first loss may be determined as (the TD loss)+∝×(the penalty loss).

In operation 750, the processor may perform online reinforcement learning. Online reinforcement learning may include an online fine-tuning stage.

The processor may apply the same constant c_{reward} to transitions collected in real time and store the transitions in the replay buffer, update the critic ensemble by equally applying reward scaling, layer normalization, and the penalty loss, and update the agent by using an average Q-value of a randomly selected subset among the critic ensemble during policy improvement.

FIG. 8 is a schematic block diagram illustrating a system for reinforcement learning according to one embodiment of the present disclosure.

Referring to FIG. 8, a reinforcement learning system 800 may include a transceiver 810, a memory 820, and a processor 830. However, not all of the components illustrated in FIG. 8 are essential components of the reinforcement learning system 800. The reinforcement learning system 800 may be implemented with more components than those illustrated in FIG. 8 or may be implemented with fewer components than those illustrated in FIG. 8. In addition, the transceiver 810, the processor 830, and the memory 820 may be implemented in the form of a single chip.

The transceiver 810 may communicate with a terminal or another electronic device connected to the reinforcement learning system 800 in a wired or wireless communication manner. Various types of data, such as programs including applications and files, may be installed and stored in the memory 820. The processor 830 may access and use the data stored in the memory 820, or may store new data in the memory 820. The memory 820 may include a database (not shown).

The processor 830 may control the overall operation of the device 800 of the reinforcement learning system 800 and may include at least one processor such as a CPU, a GPU, and the like. The processor 830 may control other components included in the reinforcement learning system 800 to perform operations for operating the reinforcement learning system 800. For example, the processor 830 may execute a program stored in the memory 820, read a stored file, or store a new file. The processor 830 may perform operations for operating the reinforcement learning system 800 by executing the program stored in the memory 820.

Offline reinforcement learning is first performed using a base dataset D_{base} that includes at least one of (i) simulator-generated trajectories Dₛᵢₘ, (ii) human teleoperation or demonstration data D_{demo}, and (iii) historical fleet/operation logs D_{fleet}. The processor pre-trains a policy and a critic ensemble on D_{base} while applying reward scaling with a constant c_{reward}>1, layer normalization (LN) within the critic networks, and penalizing infeasible actions so that Q-values for a data-unretained region (e.g., OOD actions) converge to or below a lower bound Qₘᵢₙ. In a subsequent online fine-tuning stage, the same mechanisms (reward scaling with the same c_{reward}, LN, and infeasible-action penalty) are applied to transitions collected in real time into a replay buffer, thereby preserving the suppression of Q-value overestimation outside the data-retained region while allowing safe adaptation to the deployment environment.

Fine-tuning may start in a shadow mode in which the policy is executed without issuing actuator commands to the controlled system. Transitions are still recorded to the replay buffer, and offline policy evaluation (e.g., fitted Q-evaluation) is performed until predetermined safety/consistency thresholds are met, after which the policy is activated for live control. This procedure reduces deployment risk while maintaining the advantages of online adaptation.

The system is applied to an industrial robot arm or autonomous mobile robot (AMR). The state may include joint positions/velocities/torques, exteroceptive features extracted from RGB-D or other sensors, and outputs from a motion planner; the action may include joint torques, joint velocities, or Cartesian end-effector velocity vectors. Physical safety constraints (joint limits, velocity/acceleration bounds, collision avoidance) are encoded as infeasible-action penalties so that Q-values for actions violating such constraints converge toward Qₘᵢₙ. During online fine-tuning, changes in payload, friction, illumination, or scene geometry are accommodated while retaining conservative Q-value behavior outside the data-retained region.

The system operates on a vehicle ECU or central controller. The state may include camera/LiDAR/radar/IMU/HD-map fusion results and surrounding-object states; the action may include throttle/brake commands, steering-rate, and gear selection. Traffic-law and vehicle-dynamics constraints (e.g., speed limits, lane-departure limits, maximum lateral acceleration) are reflected in the penalizing-infeasible-actions mechanism so that Q-values for constraint-violating actions are reduced to or below a predetermined bound. Offline pre-training on simulator and fleet logs (lane keeping, merges, intersections, emergency maneuvers) is followed by online fine-tuning on live road data with the same c_{reward}, LN, and penalty terms to maintain stability against OOD overestimation.

D_{base} is organized as a curriculum ranging from nominal to rare/long-tail scenarios (e.g., adverse weather, nighttime, dense traffic). The system may employ domain randomization in simulation (sensor noise, lighting, friction, terrain) to enlarge the safe A_{ODD-in} region and reduce reliance on risky extrapolation. The value of c_{reward} may be scheduled (e.g., decreasing from an offline value to an online value) to progressively widen expressivity while maintaining conservative Q-values outside the data-retained support.

During policy improvement the processor may utilize the average Q-value of a randomly selected subset of the critic ensemble to enhance robustness. Safety thresholds (e.g., minimum predicted time-to-collision margin or maximum lateral acceleration) may gate action execution; violating proposals are clipped or resampled before being recorded, strengthening the penalty loss signal for future updates.

The disclosed hybrid training may be applicable to domains with high interaction cost, including warehouse/parcel logistics, UAV navigation, process control in smart-factory lines, energy and grid control, recommendation and ad allocation, and power management on edge devices. The same workflow—offline pre-training on logs followed by online fine-tuning with shared c_{reward}, LN, and infeasible-action penalties—may enable safe initialization and low-risk adaptation.

Functions related to artificial intelligence according to the present disclosure may be operated through the processor and the memory. The processor may include one or a plurality of processors. In this case, the one or plurality of processors may be a general-purpose processor such as a CPU, an AP, or a digital signal processor (DSP), a graphics-dedicated processor such as a graphics processing unit (GPU) or a vision processing unit (VPU), or an artificial intelligence-dedicated processor such as a neural processing unit (NPU). The one or plurality of processors may control input data to be processed according to a predefined operation rule or an artificial intelligence model that are stored in the memory. In another embodiment, when the one or plurality of processors are artificial intelligence-dedicated processors, the artificial intelligence-dedicated processor may be designed with a hardware structure specialized for processing a specific artificial intelligence model.

The predefined operation rule or the artificial intelligence model may be characterized by being created through training. Here, being created through training may mean that a basic artificial intelligence model is trained using a plurality of training data by a learning algorithm, thereby creating the predefined operation rule or the artificial intelligence model configured to perform desired characteristics (or objectives). Such training may be performed on a device itself in which the artificial intelligence according to the present disclosure is performed, or may be performed through a separate server and/or system. Examples of the learning algorithm may include supervised learning, unsupervised learning, semi-supervised learning, or reinforcement learning, but are not limited thereto.

The artificial intelligence model may include a plurality of neural network layers. Each of the plurality of neural network layers may have a plurality of weight values and perform a neural network computation through a computation between results of a computation of a previous layer and the plurality of weight values. The plurality of weight values included in the plurality of neural network layers may be optimized by results of training of the artificial intelligence model. For example, during a training process, the plurality of weight values may be updated so that a loss value or a cost value obtained by the artificial intelligence model is reduced or minimized. An artificial neural network may include a deep neural network (DNN), and for example, may include a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network (DQN), but is not limited thereto.

One embodiment of the present disclosure may also be implemented in the form of a recording medium including computer-executable instructions such as program modules executed by a computer. A computer-readable medium may be any available medium that may be accessed by the computer, and may include all of volatile and non-volatile media, and removable and non-removable media. In addition, the computer-readable medium may include both computer storage media and communication media. The computer storage media may include all of volatile and non-volatile, removable and non-removable media that are implemented in any method or technology for storage of information such as computer-readable instructions, data structures, program modules, or other data. The communication media typically may include computer-readable instructions, data structures, or program modules and include any information delivery media.

The above description of the present disclosure may be for illustrative purposes, and those skilled in the art to which the present disclosure pertains will understand that various modifications can be easily made into other specific forms without departing from the technical spirit or essential characteristics of the present invention. Therefore, it should be understood that the above-described embodiments are illustrative and not restrictive in all respects. For example, each component described in a singular form may be implemented separately, and likewise, components described as being implemented separately may also be implemented in a combined form.

One embodiment of the present disclosure may include a computer-readable recording medium in which a program for executing the method according to one embodiment of the present disclosure on a computer is recorded.

One embodiment of the present disclosure may include a computer-readable recording medium in which a database used in one embodiment of the present disclosure is recorded.

One embodiment of the present disclosure, overestimation of a Q-value in a region in which data is not available can be suppressed in offline reinforcement learning.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A system for reinforcement learning, comprising:
at least one processor; and
at least one memory storing at least one instruction that, when executed by the at least one processor, is configured to:
perform offline reinforcement learning; and
perform online reinforcement learning,
wherein the performing of the offline reinforcement learning includes:
identifying a data-retained region and a data-unretained region; and
reducing a Q-value estimated for the data-unretained region.

2. The system of claim 1, wherein
the reducing of the Q-value estimated for the data-unretained region includes utilizing reward scaling that multiplies a reward function used in the offline reinforcement learning by a constant c_{reward} greater than 1 to reduce the Q-value.

3. The system of claim 1, wherein
the reducing of the Q-value estimated for the data-unretained region includes:
performing reward scaling that multiplies a reward function used in the offline reinforcement learning by a constant c_{reward} greater than 1;
performing layer normalization using a reward obtained by the reward scaling as an input; and
learning a critic ensemble including a plurality of critic networks in which the layer normalization is performed.

4. The system of claim 2, wherein
the performing of the online reinforcement learning includes performing online fine-tuning by utilizing reward scaling that multiplies a reward function of a replay buffer used in the online reinforcement learning by the constant c_{reward}.

5. The system of claim 2, wherein
the constant c_{reward} is set to a value of 10 or greater.

6. The system of claim 1, wherein
the reducing of the Q-value estimated for the data-unretained region includes penalizing that sets the Q-value for the data-unretained region to be equal to or less than a predetermined value.

7. The system of claim 6, wherein
the penalizing includes:
calculating a penalty loss;
calculating a temporal-difference (TD) loss;
determining a first loss based on the penalty loss and the TD loss; and
performing at least one of the offline reinforcement learning and the online reinforcement learning based on the first loss.

8. The system of claim 7, wherein
the first loss is determined by adding, to the TD loss, a value obtained by multiplying the penalty loss by a weight value.

9. A method for reinforcement learning performed by at least one processor, the method comprising:
performing offline reinforcement learning; and
performing online reinforcement learning,
wherein the performing of the offline reinforcement learning includes:
identifying a data-retained region and a data-unretained region; and
reducing a Q-value estimated for the data-unretained region.

10. The method of claim 9, wherein
the reducing of the Q-value estimated for the data-unretained region includes utilizing reward scaling that multiplies a reward function used in the offline reinforcement learning by a constant c_{reward} greater than 1 to reduce the Q-value.

11. The method of claim 9, wherein
the reducing of the Q-value estimated for the data-unretained region includes:
performing reward scaling that multiplies a reward function used in the offline reinforcement learning by a constant c_{reward} greater than 1;
performing layer normalization using a reward obtained by the reward scaling as an input; and
learning a critic ensemble including a plurality of critic networks in which layer normalization is performed.

12. The system of claim 10, wherein
the performing of the online reinforcement learning includes the performing online fine-tuning by utilizing reward scaling that multiplies a reward function of a replay buffer used in the online reinforcement learning by the constant c_{reward}.

13. The method of claim 9, wherein
the reducing of the Q-value estimated for the data-unretained region include penalizing that sets the Q-value for the data-unretained region to be equal to or less than a predetermined value.

14. The method of claim 13, wherein the penalizing includes:
calculating a penalty loss;
calculating a temporal-difference (TD) loss;
determining a first loss based on the penalty loss and the TD loss; and
performing at least one of the offline reinforcement learning and the online reinforcement learning based on the first loss, and
wherein the first loss is determined by adding, to the TD loss, a value obtained by multiplying the penalty loss by a weight value.

15. A computer-readable recording medium including at least one program for executing a method, the method comprising:
performing offline reinforcement learning; and
performing online reinforcement learning,
wherein the performing of the offline reinforcement learning includes:
identifying a data-retained region and a data-unretained region; and
reducing a Q-value estimated for the data-unretained region.

16. The method of claim 9, wherein
the reducing of the Q-value estimated for the data-unretained region includes utilizing reward scaling that multiplies a reward function used in the offline reinforcement learning by a constant c_{reward} greater than 1 to reduce the Q-value.

17. The method of claim 9, wherein
the reducing of the Q-value estimated for the data-unretained region includes:
performing reward scaling that multiplies a reward function used in the offline reinforcement learning by a constant c_{reward} greater than 1;
performing layer normalization using a reward obtained by the reward scaling as an input; and
learning a critic ensemble including a plurality of critic networks in which layer normalization is performed.

18. The system of claim 10, wherein
the performing of the online reinforcement learning includes the performing online fine-tuning by utilizing reward scaling that multiplies a reward function of a replay buffer used in the online reinforcement learning by the constant c_{reward}.

19. The method of claim 9, wherein
the reducing of the Q-value estimated for the data-unretained region include penalizing that sets the Q-value for the data-unretained region to be equal to or less than a predetermined value.

20. The method of claim 13, wherein the penalizing includes:
calculating a penalty loss;
calculating a temporal-difference (TD) loss;
determining a first loss based on the penalty loss and the TD loss; and
performing at least one of the offline reinforcement learning and the online reinforcement learning based on the first loss, and
wherein the first loss is determined by adding, to the TD loss, a value obtained by multiplying the penalty loss by a weight value.
